(19) United States
(12) Patent Application Publication
(10) Pub. No.: US 2013/0218826 A1
(43) Pub. Date: Aug. 22, 2013

(54) METHODS, COMPUTER-ACCESIBLE MEDIUM AND SYSTEMS FOR FACILITATING DATA ANALYSIS AND REASONING ABOUT TOKEN/SINGULAR CAUSALITY

(71) Applicants: Samantha Kleinberg, New York, NY (US); Bhubaneswar Mishra, Great Neck, NY (US)

(72) Inventors: Samantha Kleinberg, New York, NY (US); Bhubaneswar Mishra, Great Neck, NY (US)

(73) Assignee: New York University, New York, NY (US)

(21) Appl. No.: 13/580,180

(22) PCT Filed: Feb. 20, 2011
(86) PCT No.: PCT/US2011/025574

§ 371 Date: Apr. 16, 2013

Related U.S. Application Data
(60) Provisional application No. 61/306,529, filed on Feb. 21, 2010.

(51) Int. Cl. G06N 5/04

(52) U.S. Cl. CPC G06N 5/048
USPC 706/52; 706/46

(57) ABSTRACT

Exemplary embodiments of exemplary methods, procedures, computer-accessible medium and systems according to the present disclosure can be provided which can be used for determining token causality. For example, data which comprises token-level time course data and type-level causal relationships can be obtained. In addition, a determination can be made as to whether the type-level causal relationships are instantiated in the token-level time course data, and using a computing arrangement. Further, exemplary significance scores for the causal relationships can be determined based on the determination procedure. It is also possible to determine probabilities associated with the type-level causal relationships using the token-level time course data and a probabilistic temporal model and/or type-level time course data when at least one of the type-level causal relationships have indeterminate truth values. The exemplary determination of the probabilities can be performed using a prior causal information inference procedure.

### CROSS-REFERENCE TO RELATED APPLICATIONS

The present application relates to and claims priority from U.S. Patent Application No. 61/306,529 filed Feb. 21, 2010, the entire disclosure of which is hereby incorporated herein by reference.

### STATEMENT REGARDING FEDERALLY-SPONSORED RESEARCH

The present disclosure was developed, at least in part, using Government support from the National Science Foundation under CDI Grant Number 0836649. Thus, the U.S. Federal Government may have certain rights in the invention.

### FIELD OF THE DISCLOSURE

The present disclosure relates generally to exemplary methods, computer-accessible medium and systems for facilitating data analysis and reasoning about token causality, which can also be referred to as singular causality.

### BACKGROUND INFORMATION

Being able to recognize and infer type-level causality, using a process such as one described in PCT Application PCT/US09/44862, filed on May 21, 2009, the entire disclosure of which is hereby incorporated herein by reference, it is possible to answer questions such as, e.g., whether smoking causes lung cancer. This can be accomplished, e.g., by inferring whether there is a causal relationship between smoking and lung cancer. It can be desirable to relate this general notion (e.g., type cause) to a more specific token cause, such as, e.g., an individual's smoking caused the individual's lung cancer. While type-level relations can describe relationships between kinds of events, token-level relations can describe relationships between particular, actually occurring, events. A type-level relation can provide for the ability to predict the occurrence of an effect if a cause were to happen, whereas a token-level relation can provide the ability to explain one or more particular causes for a particular effect that has already happened.

For example, one type-level problem can be observing a class of people known as “Bobs” and “Susies” over time as they throw rocks at bottles; and from these observations, inferring the relationship between Bobs and Susies and broken bottles. Then, in this example, a corresponding token-level problem can be the observance of two particular people, one of type Bob and one of type Susie, as they each throw a rock at a bottle. Based on this observed situation, it is possible to determine the cause of the broken glass, for example.

Further, there can be two new people, e.g., Bill and Ted, for which it is not known whether they are of type Bob or Susie. Bill and Ted can be observed over a period of time to answer the following kinds of questions, e.g., 1) Do Bill and Ted satisfy the causal relationships of Bobs and/or Susies? 2) If there are a number of possible populations to which Bill and Ted can belong, which of these possible populations are they most similar or likely to belong. These exemplary questions do not necessarily pose token-level problems because what is being observed thus far in this example can be a sequence of events comprised of a repeated traversal of some underlying structure. An event can be a single event and/or a series of events and/or instances that together constitute a single event, for example.

While Bill and Ted can initially be thought of as individuals, Bill and Ted can also be considered to be, e.g., a new, small, population. The question here can be how to understand Bill and Ted, not what made the glass break, for example. That can be considered a type-level inference problem and can help to answer questions such as, e.g., whether it is possible to apply the Bob and Susie model to Bill and Ted, and whether if new properties of Bill and Ted that are discovered will apply to Bobs and Susies. This distinction can be described as, e.g., token-level causality can relate to the question of “why” something particular occurred on a particular occasion and type-level causality can relate to the question of “why” in general.

There can be considered to have been two facets to the problems described herein: how can one (and should one) combine type- and token-level information; and once the choice is made, how can one reason about token-causality? Among philosophers, there generally has been little to no consensus on the solution to the first problem: one can learn type-level claims first and then use these to determine token level cases (Woodward, J., Making Things Happen: A Theory of Causal Explanation, Oxford University Press, USA (2005)); the type-level relationships may follow as generalizations of token-level relationships (Hausman, D. M., Causal Relata: Tokens, Types, or Variables?, Erkenntnis 63, 1, 33-54 (2005)); or they may be treated as entirely different sorts of causation (Eells, E., Probabilistic Causality, Cambridge University Press (1991)). For the second problem, there have been a number of approaches, each with its own advantages and drawbacks. Counterfactual methods (Lewis, D., Causation, The Journal of Philosophy, 70, 17, 556-567 (1973) ask, e.g., whether the effect would have occurred in the absence of some causal factor. If not, then that factor can have caused the effect. However, in cases where there are two events that both occurred, where each alone may cause the effect, it can be possible to find that neither caused it. In later work, Lewis amended this to mean that dependencies are not based solely on whether events occur, but rather how, when and whether one event occurs depends on how, when and whether the other event occurs (Lewis, D., Causation as influence, The Journal of Philosophy 97, 4, 182-197 (2000)).

Another approach, due to, e.g., (Eells, supra.), can use probability trajectories, in which one can compare the probability of the effect before and after the cause occurs and up until the effect finally occurs in order to find a variety of relationships such as “because of “despite”, or “independently of”. This approach can be difficult to implement in practice, as it is generally considered to be rare to have enough information to be able to construct such a trajectory. In the philosophical approaches, a primary problem generally has been the practical implementation of these reasoning systems. Except in simple cases, being able to know the cause in a token case can require extensive background knowledge. Thus there has continued to be a need to be able to see what use type-level inferences can be for these token cases, for example.

Various types of causes and how they can be identified and described can be summarized as follows, for example. Causal relationships can be described as probabilistic computation tree logic (PCTL) leads-to formulas where c and e can be, e.g., any state formulas. The relationships can be inferred from, e.g., time series observations, which can be called, e.g., traces. The basic condition for causality can be that c be earlier than e, and c raise the probability of e. It is possible that these can be the minimum conditions, and that there can be a smaller window of time between c and e.

For example, c can be a prima facie cause of e if, e.g., the following conditions hold (relative to a trace, set of traces, or model):

1. F_{>0}^{<∞}c,

2. [symbol] e, and

3. F_{<p}^{<∞}e.

This definition can be considered to capture the primary feature of probabilistic theories of causality, but it can erroneously admit spurious causal relations. For example, when a barometer falls before it rains, it can appear to raise the probability of rain, but the barometer falling does not cause the rain. Thus, there can be a need to further assess which of these potential causes can be significant, comparing them with other possible explanations for the effect, for example. In order to determine whether a prima facie cause is significant, the average difference it makes to its effect given, pair-wise, each of the other prima facie causes of the same effect, can be compared. For example, if there is only one other factor with respect to which the potential cause can make only a small difference, it can still have a high average value. With X being the set of prima facie causes of e, the following can be computed:

$${ɛ}_{avg} ( c , e ) = \frac{{\sum }_{x ∈ X \backslash c} {ɛ}_{x} ( c , e )}{\vert X \backslash c \vert} ,$$

where

εₓ(c,e)=P(e|c [symbol] x)−P(e| [symbol] ĉx).

This ε_{avg} can be used to determine c's significance.

Additionally, a prima facie cause, c, of an effect, e, can be, e.g., an ε-insignificant cause of e if ε_{avg}(c,e)<ε.

Further, a prima facie cause, c, of an effect, e, that is not an ε-insignificant cause of e can be, e.g., an ε-significant, or just-so, cause.

Genuine causes can also be defined as, e.g., just-so or ε-significant causes where other conditions hold. For example, it can be known that the data can contain all common causes or variables in a set and that the data can be representative of an underlying model (such that, e.g., a formula can be satisfied by the data if it is satisfied by the model).

Computational approaches can have traditionally looked at a problem of beginning with a type-level model, and then using such to assess a particular case, for example. These models can take the form of, e.g., Bayesian networks or logical specifications of the system.

Some approaches in logic have focused on the problem of reasoning about the results of actions on the system [Lin, F., Embracing causality in specifying the indirect effects of actions, In Mellish, C., ed., Proceedings of the Fourteenth International Joint Conference on Artificial Intelligence, 1985-1991, San Francisco: Morgan Kaufmann (1995), Thielscher, M., Ramification and causality, Artificial Intelligence 89, 1-2, 317 (1997)), or diagnosing the causes of system malfunctions based on symptoms (visible errors) (Poole, D., Representing diagnosis knowledge, Annals of Mathematics and Artificial Intelligence 11, 1, 33, (1994), Lunze, J. and Schiller, F., An example of fault diagnosis by means of probabilistic logic reasoning, Control Engineering Practice, 7, 2, 271 (1999)). There has likely been a focus on reasoning about the indirect effects (ramifications) of actions. For example, how to take into account the effect of an action and propagate its changes on the world. Some work in this area can have stemmed from that of McCarthy and Hayes (McCarthy, J. and Hayes, P. J., Some philosophical problems from the standpoint of artificial intelligence, Machine Intelligence 4, 463-502, 288 (1969)), who can have been considered to have introduced the situation calculus as a method of reasoning about causality, ability and knowledge in an attempt to bring together philosophical and logical representations of the world.

Certain modifications have been since proposed (Lin, supra. and Giordano, L.; Martelli, A.; and Schwind, C., Ramification and causality in a modal action logic, Journal of Logic and Computation, 10, 5, 625 (2000)), which, generally, have attempted to determine what could follow from an event or action. However, these works likely do not allow for explanation of event, for example. Further, it can be limiting to have to begin with a model, as, in practical situations, a model is rarely provided in cases of interest, and the problem of model inference can be nontrivial. Work on fault diagnosis can generally allow for uncertainty about whether or not faults occurred and probabilistic relationships between faults and symptoms. These methods can seek an explanation for something unusual with an assumption of beginning with a set of causal knowledge or model specification. The causality usually can be interpreted in the sense of conditional dependence, and can be considered to be most similar to, e.g., the definitions employed in graphical models (Pearl, J., Causality: Models, Reasoning, and Inference, Cambridge University Press (2000)), where (absent) edges between nodes indicate conditional (in)dependence, for example. The notion of when these events occur and how much time can be between them can not be captured, though the output can be, e.g., a ranking of possible causes for a fault.

More recently, Hopkins and Pearl (Hopkins, M. and Pearl, J., Causality and Counterfactuals in the Situation Calculus, Journal of Logic and Computation 17, 5, 939 (2007)) can have been considered to have proposed a framework drawing on earlier work on structural models (Halpern, J. Y. and Pearl, J., Causes and Explanations: A Structural-Model Approach—Part 1: Causes 194-202) (2001)) as well as the work on situation calculus, for example. Structural models can have previously been used to link graphical models (Pearl, supra.) to the counterfactuals introduced by Lewis. In this more recent adaptation, it can be shown that counterfactuals can instead be modeled using the situation calculus, however one still can have to specify all dependencies, including those of counterfactuals. For example, a causal model can be a situation calculus specification of the system (including preconditions of actions, etc.) and a potential situation, and one can test whether a formula (e.g., which can be given a counterfactual interpretation) holds given the constraints on execution of the system (e.g., action preconditions).

Accordingly, there may be a need to address and/or overcome at least some of the above-described deficiencies and limitations, and to provide exemplary embodiments of method, system and computer-accessible medium for determining token causality in accordance with certain exemplary embodiments of the present disclosure, as described in further detailed herein.

### SUMMARY OF EXEMPLARY EMBODIMENTS OF THE DISCLOSURE

At least one of the objects of certain exemplary embodiments of the present disclosure can be to address the exemplary problems described herein above, and/or to overcome the exemplary deficiencies commonly associated with the prior art as, e.g., described herein. Accordingly, for example, described herein are exemplary embodiments of methods, procedures, computer-accessible medium and systems according to the present disclosure which can be used for determining token causality.

According to one exemplary embodiment of the present disclosure, a process/method may be provided that can include, e.g., obtaining data which comprises token-level time course data and type-level causal relationships, determining whether the type-level causal relationships are instantiated in the token-level time course data, and using a computing arrangement, determining significance scores for the causal relationships based on the determination procedure.

The exemplary process/method can further include determining probabilities associated with the type-level causal relationships using the token-level time course data and a probabilistic temporal model and/or type-level time course data when at least one of the type-level causal relationships have indeterminate truth values. At least one time element associated with the token-level time course data can be related to at least one time element associated with the type-level time course data. The determination of the probabilities can be performed using a prior causal information inference procedure, e.g., determining the probabilities using individual (token-level) data plus previously inferred causal relationships. The obtaining procedure can include a receipt of the data and/or determining the data. The data can include particular data associated with a probabilistic temporal model and/or type-level time course data. The type-level causal relationships can be described using a probabilistic temporal logic formula, and the probabilistic temporal logic formula can be described using at least one probabilistic computation tree logic (PCTL) formula and/or equation which formula/equation can be in the form of, e.g., [symbol] e, where c causes e in between x and y time units, with probability p.

In accordance with further exemplary embodiments of the present disclosure, the exemplary process/method can include a revision of the type-level causal relationships based on the token level determinations and probabilities associated with the token level determinations. Further, the exemplary process can include a definition of further type-level causal relationships based on information related to actual relationships. Additionally, the exemplary process can include display and/or storage information associated with the token causality in a storage arrangement in a user-accessible format and/or a user-readable format.

According to another exemplary embodiment of the present disclosure, exemplary computer-accessible medium (e.g., any of which can be non-transitory, hardware storage arrangement, etc.) is provided that can have instructions thereon for determining token causality. When the instructions are executed by a processing arrangement (which can be a hardware processing arrangement and include one or more processors), the instructions can configure the processing arrangement to obtain data which can be and/or include token-level time course data and type-level causal relationships, determine whether the type-level causal relationships are instantiated in the token-level time course data, and determine significance scores for the causal relationships based on the exemplary determination procedure, for example.

According to yet another exemplary embodiment of the present disclosure, a system is provided for determining token causality. The exemplary system can include, e.g., a computer-accessible medium having executable instructions thereon. When a computing arrangement executes the instructions, the computing arrangement can be configured to, e.g., obtain data which can be and/or include token-level time course data and type-level causal relationships, determine whether the type-level causal relationships are instantiated in the token-level time course data, and determine significance scores for the causal relationships based on the exemplary determination procedure, for example.

According to still yet another exemplary embodiment of the present disclosure, exemplary further process is provided that can include, e.g., obtaining data which comprises token-level time course data and type-level causal relationships, determining whether a cause has occurred based at least in part on the token-level time course data, and, using a computing arrangement, predicting the effect based on the obtained data and the determination procedure. The exemplary process can further include predicting a probability associated with the occurrence of the effect based on the obtained data and the exemplary determination procedure, for example.

These and other objects, features and advantages of the present disclosure will become apparent upon reading the following detailed description of exemplary embodiments of the present disclosure, when taken in conjunction with the accompanying exemplary drawings and appended claims.

### BRIEF DESCRIPTION OF THE DRAWINGS

The foregoing and other objects of the present disclosure will be apparent upon consideration of the following detailed description, taken in conjunction with the accompanying exemplary drawings and claims showing illustrative embodiments of the invention, in which:

FIG. 1 is a flow diagram showing an exemplary token causality data flow in accordance with certain exemplary embodiments of the present disclosure;

FIG. 2 is an exemplary block diagram of an exemplary system in accordance with certain exemplary embodiments of the present disclosure;

FIG. 3 is a flow diagram of exemplary first method in accordance with certain exemplary embodiments of the present disclosure; and

FIG. 4 is a flow diagram of an exemplary second method in accordance with other exemplary embodiments of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the present disclosure.

### DETAILED DESCRIPTION OF EXEMPLARY EMBODIMENTS OF THE DISCLOSURE

Obtaining (e.g., receiving, determining and/or calculating) a set of type-level causes can be considered to be an initial process in accordance with some exemplary embodiments of the present disclosure. For example, when it is desired to determine who caused a car accident, why a house caught on fire, or what made a person ill, knowing the type-level causes of accidents, fires and illness can provide some insight and hypotheses, but these relationships alone can not be enough for, e.g., the token-level causes to be determined. It can appear initially that that the type-level causes can explain these observances. However, while a type-level cause can indicate that a token-level case is likely to have a particular cause, it does not necessitate this relationship. It is also possible that a token case can correspond to multiple type-level relationships. For example, Bob's death can be a token of, e.g., “death”, “death caused by cancer”, “death caused by lung cancer”, “death of a 77-year old man”, etc.

For example, if it is suspected that there a serial killer was involved in a particular murder, one might try to show that the crime fits a known serial killer's pattern. One could likely come up with the hypothesis that the serial killer committed the crime by observing the similarity of the crime to the serial killer's pattern. However, conflating this correlation between type and token with the necessity of a token relationship following from a type one can be akin to conflating causation and correlation. An example of this would be a judicial system that used only type-level causes to determine individual cases. A type-level profile of a murderer would be developed and then every murder case would be made to fit to this mold. Even if a particular person was known to have committed a particular murder, they would be deemed innocent if they did not fit the known type-level relationships of murderers. While one can have certain hypotheses based on known type-level relationships, one should also be willing to abandon these hypotheses based on facts and other evidence contrary to such hypotheses. Thus, there can be a need for a way of reasoning about single cases that takes this into account, allowing one to use knowledge gleaned from type-level relationships while admitting the possibility that the sequence of events can be entirely different in token cases, for example.

Discrepancies between type and token can arise in two primary scenarios, for example. First, if the sample from which the type-level relationships are inferred differs from that of the token case, the single case causalities can differ. Unless one has background knowledge or can experiment on or otherwise probe the system, it can be possible to not be able to identify such a discrepancy. For example, it may be inferred that smoking can cause lung cancer within 10 to 20 years. Then, a doctor may see a patient who smoked and developed lung cancer within 10 to 20 years. However, in this example, such patient can have a genetic mutation such that smoking lowers the patient's risk of lung cancer, and in fact it was this patient's exposure to radon during the patient's career as an experimental physicist that caused the patient's lung cancer. In this example, if nothing of the connection between radon exposure and lung cancer is known, the token inferences can be incorrect. Thus, e.g., if one were to stop at the observation and inference that the patient smoked and developed lung cancer in the known time range before inquiring about radon exposure or genetic factors, an incorrect finding that smoking caused lung cancer can result. However, in order to know that it can be possible for smoking to be preventive of cancer, one can have previously had data for groups of people with the same mutation as well as for people repeatedly exposed to radon, for example. Explanations can be only as good as the current state of knowledge. Thus, it may be preferable to have previous type-level data that supports certain conclusions and/or be able to use some background knowledge to rule out type-level causes and guide the exploration of new relationships, for example.

A second example where type and token can differ is when a less significant or even a substantially insignificant type-level cause token-causes the effect. In this case, even without background information, the situation can be amenable to automated inference. It can be problematic when a more significant cause also occurs or when there can be incomplete knowledge of what occurred. For example, one highly significant type-level cause of a fire can be an unattended stove top/burner that is left on. Another less likely cause can be a lightning strike. In one case it can be known that lightning hit a house, and that a stovetop was unattended, but not whether the stovetop was on. Then, depending on the probability that the stovetop was on, given that it was unattended and there was a fire, this could be seen as either a kitchen fire or fire due to lightning strike.

In certain examples, the probability of the unattended cooking scenario can be, e.g., approximately 0.6, while that of the lightning strike scenario can be, e.g., approximately 0.3. However, if the probability of the stovetop being on is only ½, both factors can be considered as approximately equally significant in the token case. For example, perhaps unattended cooking is a much likelier cause of a fire but it can be possible to weight the significance scores c (epsilons) by the probability that the causal relationship was fulfilled. Thus, if it is known that lightning occurred, then the significance can be, e.g., ε approximately equal to 0.3, while unattended cooking can be approximately 0.5×ε=0.5×0.6=0.3. This exemplary approach can be used, e.g., where there is only partial information available and the relative importance of various causal explanations can be assessed.

An exemplary process disclosed and described herein can help one to assemble and understand facts surrounding a token event by relating these facts to type-level relationships, for which there appears to be a need to, e.g., relate general properties to singular cases. Such exemplary processes can be used, e.g., to automatically analyze token causes. In some cases, the result can be that the most significant type-level cause is the most significant token-level cause, which conclusion can be determined by, e.g., relating observations to previously determined type-level causes in accordance with the present disclosure. Since the relationships inferred can be logical formulae with time constraints between cause and effect, it can be necessary to determine whether what was seen constitutes an instance of each known relationship. If the truth value for the propositions at all times is not known, then the probability can be calculated, given the observations, of the token case being an instance of each causal relationship. Then, with a set of possible type-level relationships that could explain the token case, their significance for the token case can be ranked. According to certain exemplary embodiments, the true cause of every effect can not be determined in an error-free manner and one may not attempt to do so. Rather, the most probable causes given the type-level inferences and token-level observations can be determined.

### Exemplary Reasoning of Token Causality

Most other work in this area appears to have addressed the metaphysics of token causality, leaving open the practical problem of how to reason about such cases in an automated algorithmic way. As discussed herein above, among philosophers, there appears to be no consensus as to how to combine type- and token-level information. For example, type-level claims can be learned first and then used to determine token level cases (Woodward, supra.); the type-level relationships can follow as generalizations of token-level relationships (Hausman, supra.); or they can be treated as entirely different sorts of causation (Eells, supra.). Regardless of which approach can be considered to be advantageous over the others, and whether one (a type or token level claim) can be necessary or sufficient for the other, it is possible to make some token-level claims by, e.g., using exemplary type-level inferences as support. For example, the strength associated with exemplary type-level causes can be used to assess the strength of the token-level claims.

One exemplary way of relating these two levels of causality can be by using the Connecting Principle. Basically, according to the Connecting Principle, the support of a particular token hypothesis (e.g., that Bob's smoking caused his lung cancer) can be proportional to the strength of the type level relation (e.g., smoking causes lung cancer). The connecting principle can be stated as, e.g., if C is a causal factor for producing E in population P of magnitude m, then its support can be given by:

S{C(t₁) token caused E(t₂)|C(t₁) and E(t₂) token occurred in P}=m.

The value of the support, S(H|E), which can measure the support of H given E, can range from approximately −1 to +1. C and E can be types of causes and effects and the time-indices can indicate the token events that occur in a particular place and time, represented by tᵢ. The measure of m used by Sober can be, in fact, Eells's ADCS (average degree of causal significance). This can be restated as, e.g.,:

$$m = {\sum }_{i} [ P ( E \vert C ⋀ {K}_{i} ) - P ( E \vert C ⋀ {K}_{i} ) ] \times P ( {K}_{i} ) , \qquad ( 1 )$$

where the Kᵢs are the background contexts and this measurement denotes the magnitude of causal factor C for effect E in population P. The background contexts are formed by holding fixed all factors in all possible ways.

It can now be seen that, just as the ADCS can be replaced with ε_{avg}, for type-level inference, that ε_{avg} can be an exemplary value of m. For a particular token case, according to Sober, the relevant population can mean using whatever is known about the case. Thus, if a person's age and weight are known, then the population can be comprised of individuals with those properties, for example. If less is known, such as only that someone is a U.S. citizen, then the relevant population can be U.S. citizens. There can be separate structures for these populations (and such explicitly noted), or each bit of information defining the population can be a proposition, thus creating one structure that can allow varying results based on additional properties, for example.

One having ordinary skill in the art will appreciate that that a known type-level relationship between some c and e can be good evidence for c causing e, if it is observed that that both c and e have occurred. It can be possible that the type-level relationship alone is not enough to determine whether a general cause was a token, or singular, cause. For example, if a general relationship between c and e exists, such relationship may not mean that if e occurs, it was caused by c, especially when c did not actually occur. Thus, it can be preferable to determine whether the general causal relationships were instantiated. According to various exemplary embodiments of methods, systems and computer-accessible medium according to the present disclosure, the type-level causes can be determined based on their frequency of observation in some population. For example, if it is determined that 80% of people who develop disease X die shortly thereafter, then this provides reason to believe that if a new patient is observed to contract X and die, that such event is another instance of the disease being fatal.

### Exemplary Token Level Reasoning

The description below provides a discussion of which type-level causes can be considered as possible token causes, then describing how an exemplary embodiment can reformulate the measure of support for a token hypothesis to account for the reality of incomplete knowledge, and an exemplary procedure to calculate the probability of a particular cause occurring, and then describing exemplary procedure for assigning support to causes. For example, the ε_{avg}s computed for each causal relationship can be used to determine the support of a token causal hypotheses, with these weighted by the probability of the relationship occurring, given what has been observed. In the case where there is full knowledge of the exemplary system, the support for the hypotheses (e.g., that given a type level relationship between c and e and that c and e actually occurred in such a way as to fulfill this relationship, that c caused e) can be equal to the associated ε_{avg}. It is possible that the values of ε are not probabilities of the effect given the cause, but were computed by averaging the impact of the cause on the effect, given (pairwise) all other prima facie causes of the effect, for example.

### Exemplary Token Cause

An exemplary embodiment of the method/process according to the present disclosure can begin with a question of selecting one or more hypotheses to be further examined. An insignificant type-level cause can be a token-level cause. Indeed, a token-level cause does not have to be even a prima facie type-level cause. For example, in the case of seatbelts and automobile deaths, while in general seat belts can help prevent deaths from automobile accidents, there can be cases where seat belts in fact cause death (e.g., via a chest or neck injury). According to certain exemplary procedures in accordance with the present disclosure, it is possible to consider such cases, and not immediately rule out factors that are not causes at the token level.

At such point, it is possible that every conceivable potential cause of the effect should be enumerated, which can be an inefficient and possibly unachievable task. However, according to exemplary embodiments of the present disclosure, it is possible to calculate the support of token causal claims, with a presumption of interest in those with high levels of support. For example, if two possible token causes took place on a particular occasion and one is a type-level genuine cause while the other is a type-level insignificant cause, the more likely explanation for the effect can be that it was the token caused by the type-level genuine cause. Thus, if there are a number of token causal hypotheses, those with the highest support can be those with the highest value for ε_{avg}—e.g., exemplary just-so or genuine causes. Accordingly, if it is known that a just-so cause of the effect in question took place, it is possible that there can be no need to examine any insignificant or non-prima facie causes of the effect, as the only other causes that can have higher significance for the effect can be other just-so or genuine ones, for example. If none of the just-so or genuine causes occurred, then the hierarchy of all plausible explanations could be considered.

For example, a student, Alice, achieved a perfect score on her exam. Alice states that this was because she remembered to drink a cup of coffee before the exam. Bob disagrees and told Chris that Alice must have studied a lot. If Alice then confirms that she did spend a lot of time studying, what should Chris believe? It can be safely presumed that studying is a genuine cause for success on an exam, and it is possible that coffee is an insignificant cause for exam success. However, if prior beliefs about luck, and superstition are put aside, and if it is presumed that Chris is rational, then considering that a type-level genuine cause is known to have occurred, Chris would not continue to ask about increasingly unlikely factors once he knows that Alice has studied for the exam (i.e. a type-level genuine cause has token occurred). Even if there were other hypotheses, e.g., that she prayed that she would do well and these prayers were answered, the support for such hypotheses can be much lower than for the conclusion that her success is a result of her studying, for example.

The question of weighting the support of a hypothesis by one's belief can be considered to be an interesting one. However, exemplary procedures can be implemented with the presumption that people are rational and unbiased, e.g., that people are willing to believe the most convincing argument. One could include a myriad of prior beliefs, but it can be unclear how much that should influence the degrees of support. Certainly, it would not change the fact of what actually caused the effect. For example, whether or not a person believes that trying to blow-out a stoplight (much like blowing out a birthday candle) will make it change from red to green can have no bearing on what truly causes the change. However, if there are a number of hypotheses for why the light changed color on a particular occasion—with blowing at it being one—it can be desirable to allow individuals to have different values and thus subjective support for each token-causal hypothesis, for example.

While an insignificant cause can be a token-level cause, some exemplary procedures can begin by assessing the just-so and genuine causes. For example, the most plausible hypotheses can be considered first, and thus it is possible to miss atypical cases where there is an unusual explanation for the effect and both it and a genuine cause token-occur. However, if these more plausible causes are found not to have caused the effect, then the exemplary procedure can go back to the set of all possible causes, using the facts available about the situation to narrow these to a smaller set of those causes that are possible, and then assess the support for each of these causes. In this way, it is possible to use token events to find causal relationships that can otherwise have been missed. If there are a number of token-level instances where the only possible cause is one that was previously deemed insignificant, then such assertion can be reevaluated.

### Exemplary Support of a Causal Hypothesis

According to some exemplary embodiments of the procedures in accordance with the present disclosure, the Connecting Principle can be used in the following exemplary way. With a causal hypothesis (H) being that a particular cause c token-caused a particular effect e, evidence (E) can be that c and e token-occurred and that there is a type-level causal relationship between c and e. In some exemplary embodiments, E can denote both the type-level relationship between c and e and their token-occurrence. Accordingly, it can be possible to compute the support for H. First, using Bayes rule, the following exemplary Equation can be provided:

$$S ( H ) = {\sum }_{i} S ( H \vert {E}_{i} ) \times P ( {E}_{i} ) . \qquad ( 2 )$$

Thus, according to this example, it is possible to determine the support of an exemplary hypothesis, where S(X) is the support for X, by marginalizing over all evidence, Eᵢ.

As shown by this example, exemplary evidence can be simply the type-level relationship between c and e and their token occurrence. With this evidence still being E the following can be found:

S(H)=S(H|E)×P(E). (3)

In the cases where it is known that c and e have token-occurred, the posterior support can then be computed, where P(E)=1, which can be reduced to the following:

S(H)=S(H|E).

Since this can not always be the case, the problem can be reframed as finding S(H).

The exemplary procedure being described in this example can use the notation of c [symbol] e to denote the exemplary hypothesis H that c “led-to” e in the token case. There can be a type-level relationship between c and e and these can represent actual events occurring at particular times and places. For ease of representation, it can be possible to omit numerical subscripts and write the exemplary evidence E as: c, e. Thus,

S(c [symbol] e)=S(c [symbol] e|c, e)×P(c, e), (4)

where the support for the hypothesis given the evidence (the causal relationship and token-occurrence of c and e) can be the strength of the type-level relationship, which, in turn, could have previously been computed to be ε_{avg}(c,e), for example.

Next, the exemplary procedure can determine P(c, e), which can be the probability that c and e token-occurred and written as:

P(c, e)=P(e|c)×P(c). (5)

The relevant probability of c can not be the unconditional probability of c, but rather the posterior probability of c. If c itself is observed, then P(c) can be one. Thus, the exemplary procedure in this example can be calculating P(c|E), where E is the observed evidence, e.g., a set of facts about the particular exemplary scenario. However, there can be many such facts, with many being irrelevant. For example, when explaining a death, the day of the week on which the person died can be considered to be unlikely to have any bearing on the cause of death. However, there can be causes that while insignificant, do have some small impact. If a number of these insignificant causes together have a meaningful impact on the probability of c, then their conjunction can be a genuine or just-so cause, so one can consider the case where the cause makes a very small difference. Since together these insignificant causes can still be insignificant, a likely heuristic approach can be to limit the knowledge used to events that are part of causes and effects of c. Thus, it can be presumed that e is known, and thus P(e|c)=1, since e actually occurred. Thus, presuming that e token-occurred in population P; that the probability that c token-occurred in P is P(c); and that ε_{avg}(c,e) is the strength of the type-level relationship between c and e, then the support for the hypothesis that c token-caused e (c [symbol] e) in P can be expressed as:

S(c [symbol] e)=ε_{avg}(c,e)×P(c). (6)

### Exemplary Procedure for Determining the Probability of c

To determine the probability of a particular cause token-occurring, it can be possible to go back to the original data and use frequencies, e.g., calculating the frequency of sequences of length t where the evidence holds true. However, if the structure of the system is known or can be inferred, it can be possible to use that in the following exemplary procedure. First, as an initial matter, it is possible to determine the posterior probability of c, where the evidence is one sequence of observations, comprised of a conjunction of the facts about the scenario, for example. This exemplary evidence can be referred to as E. It can be easier to later represent the probability of [symbol] c than c and thus the interest now can be in:

P(c|E)=1−P( [symbol] c|E). (7)

### Since

$$P ( c \vert E ) = \frac{P ( c ⋀ E )}{P ( E )} , \qquad ( 8 )$$

it can be seen that:

$$P ( c \vert E ) = 1 - \frac{P ( c ⋀ E )}{P ( E )} . \qquad ( 9 )$$

Then, the facts available about the current scenario can be time-indexed by the facts at times t₁, t₂, etc., for example. These facts can constrain the set of states the exemplary system can have occupied (presuming the exemplary model of the system is correct, and that the exemplary data is representative of the system). If q is true at t=3 then at t₃ the system can be in a state labeled with q. Thus, it becomes possible to construct the set F where each fᵢ∈F is the conjunction of facts that are known to be true at time i, for i∈[0 . . . t], where time 0 is the beginning of the token event and the effect e occurred at time t. When, for a particular i, there are no known facts of that time, then fᵢ=true, for example. Otherwise, a particular fᵢ can be something like (asbestos [symbol] smoking).

The relationship between a particular cause and effect can be represented by, e.g.,

[symbol]

e, (10)

(and c and e can themselves be logical formulas) where it can be presumed y≧x and that we are computing P(c). Then, when determining the numerator of Exemplary Equation (9), the following can be added to the exemplary subset set F: { [symbol] c∈fᵢ:t−y≦i≦t−x}. For both numerator and denominator, the exemplary procedure can proceed in the same manner, with the only difference being the addition of [symbol] c to the fᵢs of the numerator, for example. The negated c can mean that c did not occur in such a way as to satisfy the formula representing the relationship between c and e. Thus the exemplary procedure can be calculating the probability of c not having happened during that time window, e.g., given e's occurrence and all other known facts about the case.

For example, with κ= [symbol] S, sⁱ, [symbol] ,L [symbol] being the structure representing the system, and where states satisfying each fⱼ∈F have been labeled as such and all states are labeled with true, then for 0≦t<∞, the probability (denoted μₘ^{t}(sₒ)) of the set of paths beginning in s₀ where each sⱼ|=κfⱼ, and the paths are of length t, can be given by the following recurrence, beginning with j=t and s=s₀:

$$P ( j , s ) = \{ \begin{matrix}1 , & if j = 0 and {f}_{i - j} ∈ labels ( s ) ; \\ 0 , & if {f}_{t - j} ∉ labels ( s ) ; \\ {Σ}_{{s}^{′} ∈ S} 𝒯 ( s , {s}^{′} ) \times P ( j - 1 , {s}^{′} ) , & otherwise .\end{matrix} \qquad ( 11 )$$

For the set of states s and integer time t, it is possible to take [symbol] (t, so) to be the sequences of states s₀→s₁→ . . . →sₜ, beginning in sₒ and where, for all j from 0 to t,

sⱼ|=κfⱼ. Then, by definition

$${μ}_{m}^{t} ( {s}_{0} ) = {\sum }_{{s}_{0} -> {s}_{1} … -> {s}_{1} ∈ Π ( t , {s}_{o} )} 𝒯 ( {s}_{0} , {s}_{1} ) \times … \times 𝒯 ( {s}_{t - 1} , {s}_{t} ) . \qquad ( 12 )$$

It can be shown by induction that the recurrence of (11) can satisfy this exemplary Equation, which is illustrated as follows.

Base case (j=0): According to the recurrence in (11), P(₀, s₀)=1 if s₀|=κf₀. By definition, the μₘ-measure of a path of one state can be 1, so μₘ^{o}(sₒ) =P(0, s₀)=1. If sₒ [symbol] κfₒ then P(o, sₒ)=o. The formula for μₘ above can only consider paths such that each sᵢ|=κfᵢ. Thus, since sₒ [symbol] κfₒ, by definition sₒ ∉Π(o, s). Adding zero can leave both μₘ and P unchanged and they thus can still be equivalent.

In an exemplary inductive procedure, if it is assumed that P(j−1, s₁)=82 ₘ^{j-1}(s₁), then P(j, sₒ)=μₘ^{j}(sₒ) can be shown. By definition:

$${μ}_{m}^{i} ( {s}_{0} ) = {\sum }_{{s}_{0} -> … -> {s}_{j} ∈ Π ( j , {s}_{0} )} 𝒯 ( {s}_{0} , {s}_{1} ) \times … \times 𝒯 ( {s}_{j - 1} , {s}_{j} ) . \qquad ( 13 )$$

This can be rewritten as:

$${μ}_{m}^{j} ( {s}_{0} ) = {\sum }_{{s}_{1}} 𝒯 ( {s}_{0} , {s}_{1} ) \times {\sum }_{{s}_{1} -> … -> {s}_{i} ∈ Π ( j - 1 , {s}_{i} )} 𝒯 ( {s}_{1} , {s}_{2} ) \times … \times 𝒯 ( {s}_{j - 1} , {s}_{j} ) . \qquad ( 14 )$$

However, P(j−1, s₁)=μₘ^{j-1}(s₁) was assumed, and since by definition

$${μ}_{m}^{j - 1} ( {s}_{1} ) = {\sum }_{{s}_{1} -> … -> {s}_{j} ∈ Π ( j - 1 , {s}_{i} )} 𝒯 ( {s}_{1} , {s}_{2} ) \times … \times 𝒯 ( {s}_{j - 1} , {s}_{j} ) , \qquad ( 15 )$$

it can be possible to find:

$${μ}_{m}^{j} ( {s}_{0} ) = {\sum }_{{s}_{1}} 𝒯 ( {s}_{0} , {s}_{1} ) \times P ( j - 1 , {s}_{1} ) \qquad ( 16 )$$

When s₀|=κf₀, this can be equal to the third item of the exemplary recurrence:

$${\sum }_{{s}^{′} ∈ S} 𝒯 ( s , {s}^{′} ) \times P ( j - 1 , {s}^{′} ) .$$

When sₒ [symbol] κfₒ, both μₘ and P are zero.

The exemplary times in this example begin at t=0, upon entry to the start state of the exemplary system. Thus, it can be possible to compute the probability of the set of paths from that start state such that each state sᵢ satisfies the corresponding fᵢ. This can mean that with E being the exemplary time-indexed evidence, including [symbol] c at the appropriate times, the recurrence above can yield the probability P( [symbol] [symbol] E) in the case where t≠∞. However, since it is possible to know that e has occurred at some actual time t, the path from sⁱ can be of length t and thus be finite. For the denominator of Exemplary Equation 9, P(E), the same exemplary procedure can be repeated, with F modified such that it does not include [symbol] c as it did for the numerator, for example. Thus, following this procedure, P(c|E) can be determined for a particular potential cause c of effect e, with evidence, using, e.g., the following exemplary embodiment of a procedure in accordance with the present disclosure.

### Exemplary Embodiment of a Procedure for Determining the Probability of a Particular Cause

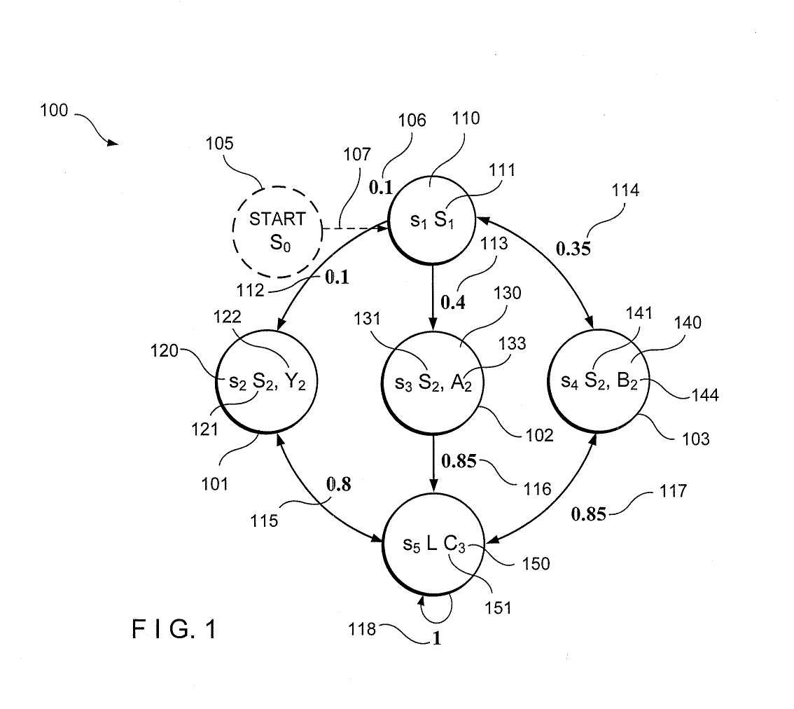

FIG. 1 illustrates an exemplary flow diagram 100 of a method/process providing an exemplary token causality data flow in accordance with certain exemplary embodiments of the present disclosure. For example, a smoking habit (S) at time 1, which is illustrated in FIG. 1 as S₁ 111, can cause lung cancer (LC) at some time 3 (i.e., two time units in the future from time 1)—which is illustrated in FIG. 1 as LC₃ 151—through three paths 101, 102, 103, respectively, corresponding to yellowing of fingers (Y), asbestos exposure (A) and recurring bronchitis (B) at some intermediate time 2 (i.e., after time 1 and before time 3) which are illustrated in FIG. 1 as Y₂ 122, A₂ 133 and B₂ 144, respectively. As also shown in FIG. 1, there can be six states, e.g., s₀ 105, s₁ 110, s₂ 120, s₃ 130, s₄ 140, s₅ 150. As further illustrated in FIG. 1, there can be probabilities 106, 112, 113, 114, 115, 116, 117, 118 of moving from one state to another state. FIG. 1 also illustrates how the exemplary flow diagram 100 can be arranged to accommodate the temporal component (e.g., time course data). For example, state s₁ 110 can correspond to time 1, states s₂ 120, s₃ 130, s₄ 140 to time 2, and state s₅ 150 time 3. Thus, as shown in FIG. 1, in this exemplary token case, it is possible to express S₁ 111 and LC₃ 151 as representing smoking at time 1 and lung cancer at time 3, respectively.

For example, a particular patient, e.g., Patrick, is known to be a smoker (S) and has been diagnosed with lung cancer (LC). Based on these exemplary facts, it can be possible to determine or compute (e.g., using a computer arrangement) probabilistic determinations with respect to, e.g., the three possible paths 101, 102, 103 from smoking at time 1 S₁ 111 to lung cancer at time 3 LC₃ 151. Since it is likely not possible to know whether Y₂ 122, A₂ 133, or B₂ 144 are true, the related probabilities can first be calculated or determined. For example, the probability, P(Y₂|S₁,LC₃) can be given by, e.g., 1−P( [symbol] Y₂|S₁,LC₃).

In this example, it is possible to utilize the expression P(Y [symbol] A [symbol] B|S,LC)=1 since, as illustrated in FIG. 1, the only exemplary paths from S₁ to LC₃ are through states s₂ 120, s₃ 130, s₄ 140, e.g., where one of the three conditions (Y, A, B) in this expression are true. These exemplary paths are illustrated in FIG. 1 as paths 102, 103, respectively. The three exemplary conditions (Y, A, B) can also be independent given S and LC. Thus, e.g.,

P(Y|S,LC)+P(A|S,LC)+P(B|S,LC)=1,

and, e.g.,

P(Y|S,LC)=1−[P(A|S,LC)+P(B|S,LC)],

where P(A|S,LC) and P(B|S,LC) can be defined as in exemplary Equation (9), for example.

Accordingly, it is possible to compute or determine:

$$\frac{P ( {Y}_{2} ⋀ {S}_{1} ⋀ {LC}_{3} )}{P ( {S}_{1} ⋀ {LC}_{3} )}$$

First, taking the numerator, K can be constructed as follows:

K={k₀=true,k₁=S,k₂= [symbol] Y,k3=LC}.

As further shown in FIG. 1, exemplary state s₀ 105 can be prior to state s₁ 110. There can be a transition from state s₀ 105 to state s₁ 110 with a probability 106 of, e.g., 0.1, as indicated by a dashed arrow 107 in FIG. 1. Accordingly, with time t=3, the set of sequences, Π(t,s), satisfying all kᵢ∈K can be expressed as, e.g.,

s₀→s₁→s₃→s₅, and

s₀→s₁→s₄→s₅,

As further illustrated in FIG. 1, in this example, there can be two paths 102, 103 from S₁ 111 to LC₃ 151 which do not include Y₂, e.g., a state where Y is true at time 2. Thus,

P(3,s₀)=T(s₀,s₁)×P(2,s₁),

where,

P(2,s₁)=T(s₁,s₃)×P(1,s₃)+T(s₁,s₄)×P(1,s₄).

Then, there can be:

P(1,s₃)=T(s₃,s₅)×P(0,s₅), and

P(1,s₄)=T(s₄,s₅)×P(0,s₅).

In both cases,

P(0,s₅)=1.

Substituting this value and the known transition probabilities, it is possible to determine:

P(1,s₃)=0.85×1=0.85, and

P(1,s₄)=0.85×1=0.85,

thus:

P(2,s₁)=0.4×0.85+0.35×0.85.

and:

$$\begin{matrix}P ( 3 , {s}_{0} ) = 0.1 \times ( 0.4 \times 0.85 + 0.35 \times 0.85 ) \\ = 0.06375\end{matrix}$$

Further, in this example, the denominator can similarly be determined with:

K={k₀=true,k₁=S,k₂=true,k3=LC}.

There can be three paths 101, 102, 103, respectively, satisfying the conditions:

s₀→s₁→s₂→s₅,

s₀→s₁→s₃→s₅, and

s₀→s₁→s₄→s₅.

FIG. 1 also shows that these three paths 101, 102, 103 can be from s₁ 110 (where S at time 1, i.e., S₁ 111, is true) to state s₅ 150 (where LC at time 3, i.e., LC₃ 151, is true).

Similarly to as described above, when determining the numerator:

P(3,s₀)=T(s₀,s₁)×P(2,s₁),

although, e.g.,

P(2,s₁)=T(s₁,s₂)×P(1,s₂)+T(s₁,s₃)×P(1,s₃)+T(s₁,s₄)×P(1,s₄).

In an exemplary procedure that can be the same or similar as described herein above, when determining the numerator, with the addition of the path through state s₂ 120:

P(1,s₂)=T(s₂,s₅)×P(0,s₅),

P(1,s₃)=T(s₃,s₅)×P(0,s₅), and

P(1,s₄)=T(s₄,s₅)×P(0,s₅).

Again:

P(0,s₅)=1.

Substituting this value and the transition probabilities can yield:

P(1,s₂)=0.8×1=0.8,

P(1,s₃)=0.85×1=0.85, and

P(1,s₄)=0.85×1=0.85.

### Thus:

P(2,s₁)=0.1×0.8+0.4×0.85+0.35×0.85,

and, e.g.,

$$\begin{matrix}P ( 3 , {s}_{0} ) = 0.1 \times ( 0.1 \times 0.8 + 0.4 \times 0.85 + 0.35 \times 0.85 ) \\ = 0.07175 .\end{matrix}$$

Substituting this exemplary result and the previous result into

$$\frac{P ( {Y}_{2} ⋀ {S}_{1} ⋀ {LC}_{3} )}{P ( {S}_{1} ⋀ {LC}_{3} )} \text{:} P ( {Y}_{2} \vert {S}_{1} , {LC}_{3} ) = 1 - \frac{0.06375}{0.07175} \approx 0.11$$

The support for Y₂ [symbol] LC₃ can be ε_{avg}(Yₜ,LCₜ₊₁)×P(Y₂), for example. To find the probabilities and thus the support for A₂ 133 and B₂ 144, it is possible to repeat this exemplary procedure, e.g., changing set K appropriately. Thus, as the calculations can proceed in the same or similar way as described herein above, for example, it is possible to express the probabilities as:

$$P ( {A}_{2} \vert {S}_{1} , {LC}_{3} ) = 1 - \frac{0.03775}{0.07175} \approx 0.47$$

$$P ( {B}_{2} \vert {S}_{1} , {LC}_{3} ) = 1 - \frac{0.042}{0.07175} \approx 0.41$$

As one having ordinary skill in the art should appreciate in view of the present disclosure, in this example, it was possible to simplify the calculations by introducing artificial times into the exemplary structure and scenario. However, it could also have been possible to, e.g., have a long gap between S₁ 111 and LC₃ 151 and a window of time in which LC could have been caused by S and the three other exemplary factors.

### Exemplary Embodiment of a Procedure for Assigning Support to Causes

According to certain exemplary procedures in accordance with the present disclosure, it can be possible to have sets of type-level genuine and insignificant causes of the token-effect in question. In order to determine the support for each, it can first be ascertained, using the facts about a situation, which of these occurred. When there is not enough information available to determine if an event has occurred, exemplary embodiment according the present disclosure can use the exemplary procedure described above to determine its probability using the observed evidence. Exemplary support for each hypothesis can be the previously computed exemplary ε_{avg}, which can be weighted by the probability of the evidence, for example. The largest possible value of the support for a token hypothesis can be, e.g., its associated ε_{avg} (since the probability can be at most one). If any significant type-level causes, which can also be referred to as, e.g., genuine or just-so type-level causes, have occurred, this can mean that they will have the highest values of this support, for example. As an exemplary goal can be to find the likeliest causes, e.g., those with the most support, the exemplary procedure can take these sets and test whether any of their members are true on the particular occasion.

For example, with C being the set of just-so and genuine causes of the token-effect, e, and F being the set of known facts, it can be possible to test whether each C∈C is true on this occasion given the facts. Those having ordinary skill in the art should appreciate, e.g., how this procedure can be used with the procedures described herein for calculating the probability of a cause in order to do so without a model. Some exemplary types of formulas and their truth values can be as follows:

1. Each atomic proposition can be a state formula.

2. If g and h are state formulae, so can be [symbol] g, g [symbol] h, g [symbol] h, and g→h.

In this example, an atomic proposition, g, can be true at time t if it actually occurred at t. Conversely, [symbol] g can be true at t if g is not true at t. Accordingly, g [symbol] h can be true at t if both g and h are true at t; g [symbol] h can be true at t if at least one of g or h is true at t and g→h can be true at t if at least one of [symbol] g or h is true at t.

3. If f and g are state formulae, and s is a nonnegative integer or ∞, fU^{≦s}g and fU^{≦s}g can be path formulae. Similar formulae can also be defined with lower bounds on the time windows, such that g is true within some period of time such as [r, s], for example.

In this example, the path formula fU^{≦s}g can be true for a sequence of times, beginning at time t if there exists an 0≦i≦s such that at time t+i, the state formula g is true and ∀j: 0≦j<i the state formula f can be true at t+j. The path formula fU^{≦s}g can be true for a sequence of times beginning at time t if either fU^{≦s}g is true beginning at t or ∀j: 0≦j≦s, f can be true at t+j.

Additionally, in this example,

4. If f is a path formula and 0≦p≦1, [f]_{≧p} and [f]_{>p} can be state formulae.

In an exemplary token case, these state formulae can be true at time t if there is a sequence of times, e.g., beginning at t, that satisfy the path formula f. Following this formulation, it can be possible to identify whether any c∈C are true on the occasion in question, in which case their support can be simply the associated ε_{avg} values. In examples where this set is empty, the conclusion can be that none occurred or that there is not enough information to determine whether any occurred, in which case exemplary probabilities can be calculated. One cannot assume, e.g., that if the probability of a significant cause is non-zero, then the support for the corresponding token hypothesis will be greater than for any insignificant causes. Rather, in examples where it is not tested whether any insignificant causes actually occurred, it is possible that for a genuine cause, c, P(c) can be low enough that despite its higher value for ε_{avg}, an actually occurring (probability=1) insignificant cause can have a larger value for the support (ε_{avg}×P(c)). In the case where there are many insignificant causes, testing whether each occurred can be computationally intensive. Thus, it can be possible to define a threshold such that if the support for a cause is below it, insignificant and other causes are examined.

An exemplary procedure in accordance with the present disclosure can begin with the probabilities, and thus support, for the genuine and just-so causes. When these values are very low or zero, the other potential explanations can be examined, e.g., such as any previously discarded insignificant causes, and those that are not even prima facie causes, for example. Further, it is possible that a negative cause, e.g., one that normally prevents the effect, actually was the token cause. After examining these factors, the final result can be a set of possible explanations ranked by their support, with those having the highest values being the preferred explanations for the effect, for example.

### Additional Examples of Token Causality

With reference to the above example with Bob and Susie, each one of them can be armed with rocks that they can throw at a glass bottle. It is possible, e.g., that one type level genuine cause has been found (with the other causes being insignificant) of such a bottle breaking in this system. This exemplary relationship can be represented by:

[symbol]

G.

For example, throwing (T) a rock from a certain distance can causes the glass to break (G) in greater than or equal to one time unit, but less than or equal to two time units, with at least probability p₁. Since this can have been found to be a type-level cause, the associated values of ε_{avg} for the relationship (ε_{avg}(T,G)) can be determined.

An exemplary procedure can perform an analysis, starting with the following facts for this example:

1. Bob threw his rock at time 3;

2. Susie threw her rock at time 4;

3. The glass broke at time 4;

4. The only genuine cause of a broken glass is that in formula 17.

An exemplary corresponding timeline can be expressed as follows.

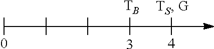

For each proposition (T, G), its time of occurrence can be marked, e.g., with T_{B} denoting T being true due to Bob's throw and T_{S} denoting T being true due to Susie's throw, for example. In this example, the exemplary type level relationship provides that if T is true at some time t, then it can lead to G being true at time t+1 or t+2. The initial facts can be, e.g., that T is true at t=3 and at t=4. The exemplary procedure can first test whether the exemplary type level relations token-occurred. T_{B} can satisfy the causal formula of 17 when G is true at t=4 or t=5. In this example, G is true at t=4 and thus T_{B} can be considered as a possible token-cause of G. T_{S} can be a token cause of G, when G is true at t=5 or t=6. However, in this example, G is true at t=4, which can mean that this causal relationship did not occur, and that T_{S} is not a possible token cause (since, e.g., it could not lead to G at the time at which G actually occurred). Thus, in this exemplary case, the only potential token cause can be T_{B}, and the support for this token cause can be ε_{avg}(T,G). While in the exemplary system according to this example, T_{B} caused G, the support for the hypothesis that T_{B} token-caused G is not one. If T had an ε_{avg} of one, e.g., meaning that it is the only type-level cause of the effect and no other factors make any difference, then the support could be one.

### FURTHER EXAMPLES

Following are exemplary classic scenarios that typically have been difficult to reason about in the token case.

Overdetermination, Symmetric Case Example

Symmetric overdetermination can be where two known type-level causes of an effect both occur in the token case such that either could have caused the effect. With reference to the above Bob and Susie examples, there can be two people, each armed with a rock, which they can throw at a glass bottle. In this example, Bob can be standing a little closer to the bottle than Susie. Thus, Susie can aim and throw (Sₜ) her rock a little earlier than Bob does (Bₜ) so that their rocks hit the glass simultaneously, breaking (G) it shortly after impact. Such exemplary scenario, for example, can correspond to the following type-level relationships:

[symbol]

G, and (18)

[symbol]

G, (19)

where people of type Bob, who stand closer to the bottle in this rock-throwing game, can be represented by B and the relationship in exemplary Equation (18), and those of type Susie, who stand further from the bottle, can be represented by S and the relationship in exemplary Equation (19). In this example, the facts can be:
1. Susie threw her rock at t=1
2. Bob threw his rock at t=3
3. The glass broke at t=4
4. The only significant causes of a broken glass are those in exemplary Equations (18) and (19).

This example case scenario can be analyzed as follows. First, it can be observed that both B_{T} and S_{T} occurred in such a way as to satisfy the exemplary Equations (18) and (19). For B_{T} at time 3 to cause G, G can have had to occur between time 4 and 5, which it did, and for S_{T} at time 1 to cause G, it can have had to occur between times 4 and 6, which is also true. Thus it can now be known not only that the probability of each potential cause given the evidence is one, but also that each can have occurred at such a time so as to fulfill the corresponding token-level relationships. The support for B_{T} and S_{T} causing G can be, e.g., the computed ε_{avg}'s. If these are equal, the support for either as the token-cause of the glass breaking can be the same. However, if Susie's aim is better, her value of ε_{avg} can be larger and thus the support for her breaking the bottle can be higher. In such case, it can be said that there is more support (proportional to the difference in probability) for S_{T} than B_{T} causing G, as opposed to saying that Bob's throw did not cause the glass to break.

While this exemplary case can appear to be simple, it may be difficult for other approaches attempting to solve this exemplary type of problem, including, e.g., those approaches based on counterfactuals, where it would be tested whether if B_{T} had not occurred, G would not have occurred, and the same for S_{T}. However if either rock had not been thrown or had not hit the glass, the other rock would have broken the bottle, so it is possible using this other approach that neither rock is found as a cause of the bottle breaking. With respect to other exemplary cases of a similar type, such as, e.g., determining possible culprits for a patient's heart failure, it can be desirable to be able to identify multiple potential causes, with their associated weights.

Overdetermination, Asymmetric Case Example

In the previous exemplary case example described herein above, it is possible that either rock being thrown could have been the cause of the bottle breaking. The following example differs from the symmetrical case example as, e.g., it is asymmetrical and exemplifies what can be called “preemption”.

In this asymmetrical example, Bob throws his rock a bit earlier than Susie throws hers, so his rock hits and breaks the glass before hers does. Now the bottle is already broken when Susie's rock hits it. Accordingly, Bob's throw can be deemed the cause of the glass breaking. If S_{T} occurs at such a time that it could have caused G (according to the inferred rules), then there can be no way to account for the fact that the bottle is already broken, e.g., the type-level relationships can not be augmented with observations to provide further constraints. However, since there can be a small window of time in which a rock hitting a bottle can cause the bottle to break, if the events can be finely modeled, e.g., using variables such as B_{H} and S_{H} to denote whether the corresponding rocks have hit the bottle, then this case can be correctly handled.

If, in practice, an incorrect diagnosis is found using exemplary inferred type-level causes, such can be taken as an indication that these are too coarsely grained to capture the details of the system. Accordingly, it can be preferable to go back and look for relationships with more detail and at a finer timescale.

This exemplary type of case has traditionally been considered to be difficult for methods that look for the earliest cause that can account for the effect. For example, if Susie throws a rock earlier than Bob, but is standing further away, so that her rock still hits after the glass is broken, using such other methods can incorrectly find that since she threw the first rock, she caused the bottle to break. Exemplary embodiments of the present disclosure can take into account other facts so as to not lead to this incorrect conclusion. For example, by using the actual times of events, exemplary processes in accordance with the present disclosure can correctly handle cases where the effect has already occurred (e.g. where the bottle is already broken when Susie's rock hits it). This difficulty can be due to not modeling the events finely enough and/or not being able to account for observations that are outside the causal formulae. For example, had the rocks not been observed hitting the bottle, the notion that either throw could have caused the glass to break could be acceptable. The contradiction can be that it cannot always be possible to augment the type-level relationships with observations of further constraints. More specific type-level relationships could be sought, using, e.g., the rock hitting the bottle as an event, or specifying that the rock hits an unbroken bottle, for example.

The Exemplary “Hard Way”

Another set of examples can have the same structure, but highlight various features of the problem as well as the differing intuitions one can have in each case. In these types of exemplary scenarios, a cause of the effect can occur, followed by an event that can usually make the effect less likely, but which, in this particular case, seems to bring about the effect. Thus, an exemplary effect can have occurred, but can have happened the “hard way”—e.g., with most of the odds against it happening. For example, the following exemplary case is of a car accident in which a seatbelt causes death.

In this example, the facts are as follows: on a Monday morning, Paul drove his car to work, wearing his seatbelt as he always does. Unfortunately, on this particular drive he was in a bit of a rush and collided head on with an ice cream truck. The collision resulted in injury to Paul's carotid artery, due to which he later died.

Presuming that only a general type-level relationship between seatbelts and death is known (e.g., not one involving carotid artery injury specifically). This relationship can account for a myriad of ways (including by carotid artery injury) a seat belt can cause death. However, since seatbelts generally prevent death, the associated probability can be relatively very low. In this example, it can further be presumed that a seatbelt can only cause death in the context of a car accident. Accordingly, the exemplary general relationships between death (D), car accidents (C) and wearing a seat-belt (S) can be:

P(D|C [symbol] S)>P(D|C [symbol] S)>P(D), (20)

and a general relationship between car accidents and death:

P(D|C)>P(D). (21)

As shown, it can be possible to omit the time subscripts and assume the token events are within the known type-level time frames. This can be akin to the probability of death within some window of time, versus the probability of death within some window of time given that the person has been in a car accident. While it can be that being in a car accident and not wearing a seatbelt can be a significant type-level cause of death, being in a car accident and wearing a seatbelt can result in a lower probability of death, for example. However, it can still be at least a prima facie cause of death. It can seem unlikely that seatbelt use plus a car accident should be a negative cause of death, so such possibility can be disregarded in this example.

Given that there can be the relationship, C [symbol] D, which can be a significant type-level cause of death, it is possible to find that, e.g., it occurred in the token case, it is the only type-level genuine or just-so cause that occurred (since, e.g., C [symbol] S is false), and it has a value of support equal to the associated ε_{avg}. This can mean that unless C [symbol] S is a significant type-level cause, it can be possible that one would not automatically consider it as a possible explanation for the effect. Thus, regardless of whether the specific injury was caused by the seatbelt, the car accident can still be considered as having caused the death in this example. As one of the presumptions can be that a seatbelt injury only occurs within the context of a car accident, this exemplary case can be thought of as, e.g., death by car accident, with the mechanism being carotid artery injury due to the seatbelt. In this example, there can be a general relationship between car accidents and death, and this relationship can be fulfilled by a variety of means, e.g., seatbelt injury, airbag injury, ejection, etc.

It can still be desirable to test the hypothesis of C [symbol] S causing death, similarly to how other unlikely hypotheses outside our general algorithm can be tested, as described herein above. In this exemplary case, it can be seen that it did occur and its support can be equal to its ε_{avg}, which can be less than that of C as a cause of death. Thus, what can be known to be the “actual cause” can have less support than a more general cause. This exemplary case can have a slightly different structure than other cases of similar type, e.g., the inclusion of the general car accident-death relationship. In the modified exemplary seatbelt case, where the relationship C [symbol] D can be omitted, it can be possible to have no occurring significant type-level causes. Thus, insignificant and other causes can be examined, for example. In this case, C [symbol] S can be found to be the only known potential cause and can again have low support. Accordingly, it can be said that this was an unlikely occurrence, but the seeming cause of death.

While it can be possible to explain the occurrence of an effect using type-level causal relationships and token-level observances, it can also be possible to predict an effect using the same exemplary procedures described herein with relatively minor modifications, for example. For prediction, the effect has not yet occurred. Thus, an exemplary procedure can begin with, e.g., one or more sets of token-level time course data and at least one set of type-level causal relationships. Each of the type-level relationships can be expressed in the form of:

[symbol]

e,

which can denote c leading to (or causing) e in between x and y time units (where 0≦x≦y≦∞ and x≠∞) with probability p, for example.

Exemplary c and e in this example can themselves be logical formulas. It can then be possible to determine whether, given the evidence of the token-level time course observations, c is true (e.g., if the formula is satisfied by the data), using the procedure used previously for determining whether a formula is satisfied by a sequence of data. Similarly to the examples described herein above, it is not possible to determine whether c is satisfied, a probability can be calculated given the token-level time course observations and a type-level model and/or type-level time course data. In this example, however, it is possible to determine both the probability of c and of e given the observations and the type-level model or data. Then, if c is satisfied, the probability of e in the time window [x, y] can be p. If it is unclear whether c is satisfied, the probability of e can be that calculated based on the observations, for example.

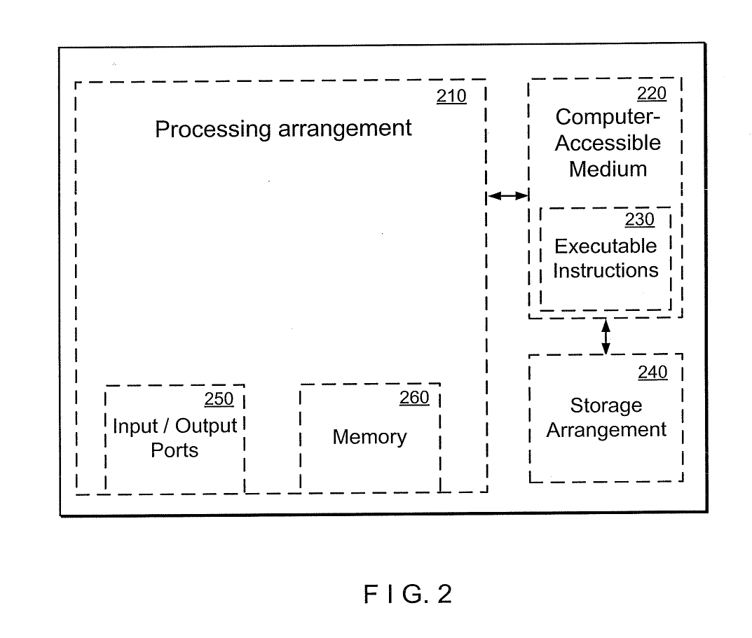

FIG. 2 shows an exemplary block diagram of an exemplary embodiment of a system according to the present disclosure. For example, an exemplary procedure in accordance with the present disclosure can be performed by a processing arrangement 210 and/or a computing arrangement 210. Such processing/computing arrangement 210 can be, e.g., entirely or a part of or include, but not limited to, a computer/processor that can include, e.g., one or more microprocessors, and use instructions stored on a computer-accessible medium (e.g., RAM, ROM, hard drive, or other storage device).

As shown in FIG. 2, e.g., a computer-accessible medium 220 (e.g., as described herein, a storage device such as a hard disk, floppy disk, memory stick, CD-ROM, RAM, ROM, etc., or a collection thereof) can be provided (e.g., in communication with the processing arrangement 210). The computer-accessible medium 220 can contain executable instructions 230 thereon. In addition or alternatively, a storage arrangement 240 can be provided separately from the computer-accessible medium 220, which can provide the instructions to the processing arrangement 210 so as to configure the processing arrangement to execute certain exemplary procedures, processes and methods, as described herein, for example.

Further, the exemplary processing arrangement 210 can be provided with or include an input/output arrangement 250, which can include, e.g., a wired network, a wireless network, the internet, an intranet, a data collection probe, a sensor, etc. As shown in FIG. 2, the exemplary processing arrangement (computing arrangement) 210 can further be provided with and/or include exemplary memory 260, which can be, e.g., cache, RAM, ROM, Flash, etc. Further, the exemplary processing arrangement (computing arrangement) 210 can be in communication with an exemplary display arrangement which, according to certain exemplary embodiments of the present disclosure, can be a touch-screen configured for inputting information to the processing arrangement in addition to outputting information from the processing arrangement, for example. Further, the exemplary display and/or storage arrangement 240 can be used to display and/or store data in a user-accessible format and/or user-readable format.

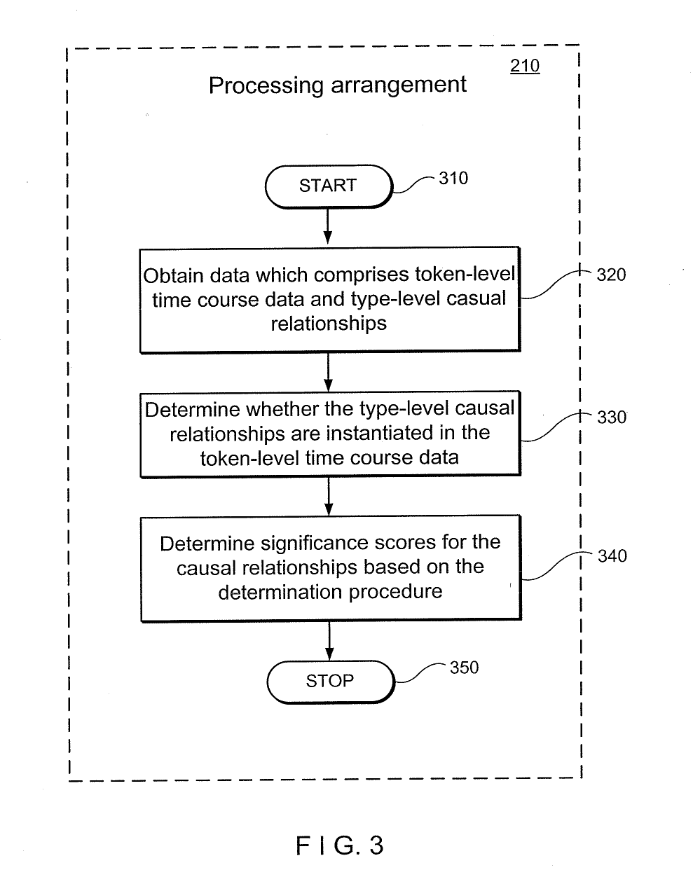

FIG. 3 illustrates an exemplary process/method showing exemplary procedures for facilitating the data analysis with temporal logic of token causes in accordance with certain exemplary embodiments of the present disclosure. As shown in FIG. 3, the exemplary procedure can be executed on and/or by, e.g., the processing/computing arrangement 210 of FIG. 2. For example, starting at subprocess 310, in accordance with certain exemplary embodiments of the present disclosure, the processing/computing arrangement 210 can, in subprocess 320, obtain data which comprises token-level time course data and type-level causal relationships. In subprocess 330, the exemplary processing/computing arrangement 210 can determine whether the type-level causal relationships are instantiated in the token-level time course data. Then, in accordance with certain exemplary embodiments of the present disclosure, in subprocess 340, the exemplary processing/computing arrangement 210 can determine significance scores for the causal relationships based on the determination procedure, for example.

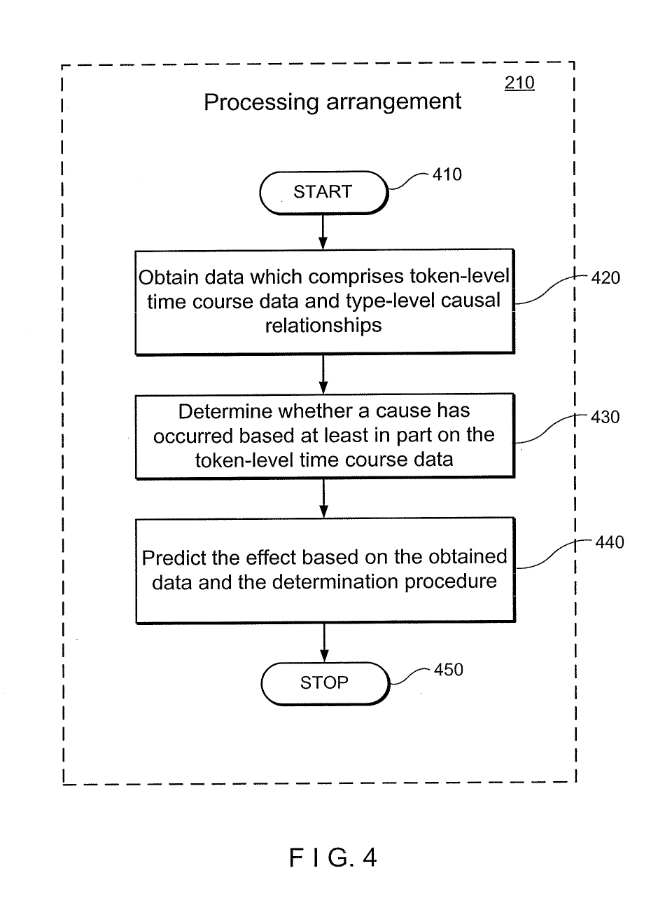

FIG. 4 illustrates another process/method showing exemplary procedures for facilitating data analysis with temporal logic of token causes in accordance with certain exemplary embodiments of the present disclosure. As shown in FIG. 4, the exemplary procedure can be executed on and/or by, e.g., the processing/computing arrangement 210 of FIG. 2. For example, starting at subprocess 410, in accordance with certain exemplary embodiments of the present disclosure, the exemplary processing/computing arrangement 210 can, in subprocess 420, obtain data which comprises token-level time course data and type-level causal relationships. In subprocess 430, the exemplary processing/computing arrangement 210 can determine whether a cause has occurred based at least in part on the token-level time course data. Then, in accordance with certain exemplary embodiments of the present disclosure, in subprocess 440, the exemplary processing/computing arrangement 210 can predict and/or determine an effect based on the obtained data and the determination procedure, for example.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of the invention and are thus within the spirit and scope of the invention. In addition, all publications and references referred to herein are hereby incorporated herein by reference in their entireties. It should be understood that the exemplary procedures described herein can be stored on any computer-accessible medium, including, e.g., a hard drive, RAM, ROM, removable discs, CD-ROM, memory sticks, etc., included in, e.g., a stationary, mobile, cloud or virtual type of system, and executed by, e.g., a processing arrangement which can be or include one or more hardware processors, including, e.g., a microprocessor, mini, macro, mainframe, etc.

What is claimed is:

1. A process for determining token causality, comprising:
obtaining data which comprises token-level time course data and type-level causal relationships;
determining whether the type-level causal relationships are instantiated in the token-level time course data;
using a computing arrangement, determining significance scores for the causal relationships based on the determination procedure.

2. The process of claim 1, further comprising determining probabilities associated with the type-level causal relationships using the token-level time course data and at least one of a probabilistic temporal model or type-level time course data when at least one of the type-level causal relationships have indeterminate truth values.

3. The process of claim 2, wherein at least one time element associated with the token-level time course data is related to at least one time element associated with the type-level time course data.

4. The process of claim 2, wherein the determination of the probabilities is performed using a prior causal information inference procedure.

5. The process of claim 1, wherein the obtaining procedure comprises receiving the data.

6. The process of claim 1, wherein the obtaining procedure comprises determining the data.

7. The process of claim 1, wherein the data includes particular data associated with at least one of a probabilistic temporal model or type-level time course data.

8. The process of claim 7, wherein the type-level causal relationships are described using a probabilistic temporal logic formula.

9. The process of claim 8, wherein the probabilistic temporal logic formula is described using at least one probabilistic computation tree logic (PCTL) formula.

10. The process of claim 8, wherein the probabilistic temporal logic formula is in the form of: [symbol]
e,
wherein c causes e in between x and y time units, with probability p.

11. The process of claim 1, further comprising revising the type-level causal relationships based on the token level determinations and probabilities associated with the token level determinations.

12. The process of claim 1, further comprising defining further type-level causal based on information related to actual relationships.

13. The process of claim 1, further comprising at least one of displaying or storing information associated with the token causality in a storage arrangement in at least one of a user-accessible format or a user-readable format.

14. A computer-accessible medium containing executable instructions thereon, wherein when at least one computing arrangement executes the instructions, the at least one computing arrangement is configured to perform procedures comprising:
obtaining data which comprises token-level time course data and type-level causal relationships;
determining whether the type-level causal relationships are instantiated in the token-level time course data;
determining significance scores for the causal relationships based on the determination procedure.

15. A system for determining token causality, comprising:
a computer-accessible medium having executable instructions thereon, wherein when at least one computing arrangement executes the instructions, the at least one computing arrangement is configured to:
obtain data which comprises token-level time course data and type-level causal relationships;
determine whether the type-level causal relationships are instantiated in the token-level time course data; and
determine significance scores for the causal relationships based on the determination procedure.

16. A process for predicting an effect, comprising:
obtaining data which comprises token-level time course data and type-level causal relationships;
determining whether a cause has occurred based at least in part on the token-level time course data;
using a computing arrangement, predicting the effect based on the obtained data and the determination procedure.

17. The process of claim 16, further comprising determining a probability associated with the occurrence of the effect based on the obtained data and the determination procedure.

18. The process of claim 16, wherein the data includes particular data associated with at least one of a probabilistic temporal model or type-level time course data.

19. The process of claim 18, wherein the type-level causal relationships are described using a probabilistic temporal logic formula.

20. The process of claim 19, wherein the probabilistic temporal logic formula is described using at least one probabilistic computation tree logic (PCTL) formula.
